(19) United States
(12) Patent Application Publication
(10) Pub. No.: US 2015/0058655 A1
(43) Pub. Date: Feb. 26, 2015

(54) INTERFACE CIRCUIT AND SYSTEM

(71) Applicant: KABUSHIKI KAISHA TOSHIBA, Tokyo (JP)

(72) Inventors: Shigeru Ishimoto, Sagamihara-shi (JP); Motoaki Koyama, Yokosuka-shi (JP); Seiichiro Saito, Kawasaki-shi (JP); Hiroyuki Michie, Kawasaki-shi (JP); Kazuya Kimura, Yokohama-shi (JP)

(73) Assignee: KABUSHIKI KAISHA TOSHIBA, Tokyo (JP)

(21) Appl. No.: 14/204,065

(22) Filed: Mar. 11, 2014

(30) Foreign Application Priority Data
Aug. 26, 2013 (JP) 2013-174857

(51) Int. Cl. G06F 1/12

(52) U.S. Cl. CPC G06F 1/12
USPC 713/375

(57) ABSTRACT

According to one embodiment, there is provided an interface circuit including a plurality of units. Each of the plurality of units includes a clock interface, a data interface, and a selector. The clock interface receives a clock and transfers the clock. The data interface receives data and transfers the data. The selector selects a clock and supplies the selected clock to the data interface such that the data interface transfers the data in synchronization with the selected clock.

### CROSS-REFERENCE TO RELATED APPLICATIONS

This application is based upon and claims the benefit of priority from Japanese Patent Application No. 2013-174857, filed on Aug. 26, 2013; the entire contents of all of which are incorporated herein by reference.

### FIELD

Embodiments described herein relate generally to an interface circuit and a system.

### BACKGROUND

An interface circuit acts as an interface between a system and an external module when the external module is connected to the system therethrough. For example, when the external module is connected to the interface circuit, a clock and data from the external module are transferred to a controller or the like of the system via the interface circuit. It is desirable to increase degree of freedom of external connection.

### BRIEF DESCRIPTION OF THE DRAWINGS

FIG. 1 is a schematic diagram of one example of a configuration of a system to which an interface circuit is adapted according to an embodiment;

FIG. 2 is a schematic diagram of one example of a circuit configuration of an interface circuit according to an embodiment when firmware FW1 is selected;

FIG. 3 is a schematic diagram of one example of a configuration of layout and a clock transmission path of a plurality of units of an interface circuit according to an embodiment when firmware FW1 is selected;

FIG. 4 is a schematic diagram of one example of a circuit configuration of an interface circuit according to an embodiment when firmware FW2 is selected;

FIG. 5 is a schematic diagram of one example of a configuration of layout and a clock transmission path of a plurality of units of an interface circuit according to an embodiment when firmware FW2 is selected;

FIG. 6 is a schematic diagram of one example of a circuit configuration of an interface circuit according to an embodiment when firmware FW3 is selected;

FIG. 7 is a schematic diagram of one example of a configuration of layout and a clock transmission path of a plurality of units of an interface circuit according to an embodiment when firmware FW3 is selected; and

FIG. 8 is a schematic diagram of one example of a configuration of a system to which an interface circuit is adapted according to an example.

### DETAILED DESCRIPTION

In general, according to one embodiment, there is provided an interface circuit including a plurality of units. Each of the plurality of units includes a clock interface, a data interface, and a selector. The clock interface receives a clock and transfers the clock. The data interface receives data and transfers the data. The selector selects a clock and supplies the selected clock to the data interface such that the data interface transfers the data in synchronization with the selected clock.

Exemplary embodiments of an interface circuit and a system will be explained below in detail with reference to the accompanying drawings. The present invention is not limited to the following embodiments.

### Embodiment

Prior to describing an interface circuit 100 in accordance with the embodiment, an interface circuit 1 according to a basic mode is described as follows.

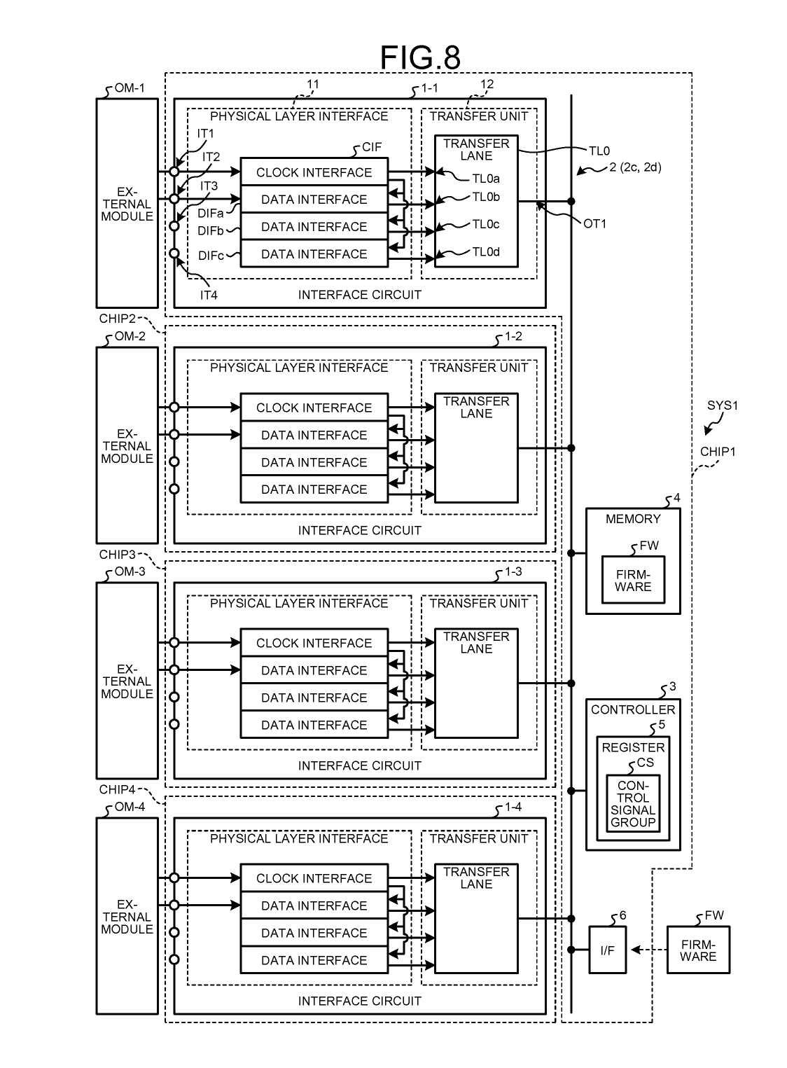

The interface circuit 1 acts as an interface between a system and an external module when the external module is connected to the system therethrough. For example, the interface circuit 1 is implemented on a system SYS 1 as shown in FIG. 8. The system SYS 1 includes a system of a mobile terminal or a system of a personal computer, for example. An external module OM is connected to the system SYS 1 through the interface circuit 1. The external module OM includes a camera module or a controller module, for example.

Specifically, the system SYS 1 may include a bus 2, the interface circuit 1, a controller 3, a memory 4, and an interface (I/F) 6.

The bus 2 connects the interface circuit 1, the controller 3, the memory 4, and the interface (I/F) 6 each other so that a signal is transferred therebetween. The bus 2 transfers the signal (i.e., a clock and data) in synchronization with a clock that is transmitted from the external module OM. That is, the bus 2 has a characteristic meeting a standard in which a bus transfers the signal in synchronization with a clock that is transmitted from the external module OM. Such a standard includes MIPI (Mobile Industry Processor Interface), MDDI (Mobile Display Digital Interface), or 12C (Inter-Integrated Circuit), for example. The bus 2 may include a bus 2c for clock and a bus 2d for data, for example.

The interface circuit 1 receives a clock and data from the external module OM and transfers the received clock and data to the controller 3 and the like via the bus 2.

In a case where the external module OM is a camera module, the camera module includes a lens, an image sensor, a clock generator and the like. The camera module captures image of the subject in synchronization with a clock to transmit image data of the captured image (still or moving image) and the clock to the interface circuit 1. In this case, the interface circuit 1 may be a camera serial interface, for example.

Alternatively, in a case where the external module OM is a controller module, the controller module may include a controller, a clock generator and the like, for example. The controller module works in synchronization with a clock to determine control instructions for the controller 3 and transmit a control data according to the determined control instructions and a clock to the interface circuit 1. In this case, the interface circuit 1 may be a controller serial interface, for example.

The interface circuit 1 is connected to the bus 2 through an output terminal OT1, as well as being connected to the external module OM through at least one of a plurality of input terminals IT1-IT4. Each of the plurality of input terminals IT1-IT4 has a characteristic meeting the bus standard above described, and includes the input terminal IT1 for a clock and the input terminals IT2-IT4 for data. As can be seen in FIG. 8, the external module OM is connected to the interface circuit 1 through an input terminal IT1 for a clock and an input terminal IT2 for data.

For example, the interface circuit 1 may include a physical layer interface (PHY) 11 and a transfer unit 12.

The physical layer interface 11 receives a clock and data from the external module OM to output the clock and data to the transfer unit 12. The physical layer interface 11 includes a clock interface CIF and data interfaces DIFa to DIFc.

A clock interface CIF receives clock from the external module OM via an input terminal IT1. The clock interface CIF transfers a clock to the bus 2 in synchronization with the clock. That is, the clock interface CIF uses the received clock as a clock for transfer operation and transfers the clock itself to the bus 2. The clock interface CIF, for example, may be configured by a plurality of shift registers (not shown) which transfer the signal (clock) in synchronization with the clock. Each of the plurality of shift registers may be a D latch (not shown). The clock interface CIF outputs the transferred clock to the data interfaces DIFa to DIFc together with a transfer unit 12. The clock interface CIF may be referred as to a clock lane because the clock interface CIF functions as a transmission lane to transfer the clock upon receiving the clock.

A data interface DIFa receives data from the external module OM via input terminal IT2. The data interface DIFa transfers the data in synchronization with the clock. The data interface DIFa, for example, may be configured by a plurality of shift registers (not shown) which transfer the data in synchronization with the clock. Each of the plurality of shift registers may be a D latch (not shown). The data interface DIFa outputs the transferred data to the transfer unit 12. The data interface DIFa may be referred as to a data lane because the data interface DIFa functions as a transmission lane to transfer the data upon receiving the data.

It should be noted that configurations and operations of the data interface DIFa can be similar to that of data interfaces DIFb and DIFc.

The transfer unit 12 receives a clock and data from the physical layer interface 11. The transfer unit 12 outputs the clock and data to the bus 2 via an output terminal OT1. The transfer unit 12 has a transfer lane TL0.

The transfer lane TL0 receives a clock from the clock interface CIF via a terminal TL0a and receives data from the data interfaces DIFa to DIFc via terminals TL0b-TL0d, respectively. The transfer lane TL0 transfers a clock to the bus 2c for a clock, and transfers data to the bus 2d for data. When receiving a plurality of data simultaneously, the transfer lane TL0 determines an order of data processing by arbitration scheme, for example, to output a piece of data to the bus 2d for data according to the determined order sequentially. The order of data processing may be an order of terminals TL0b-TL0d which is selected in a manner of cyclic (in round-robin manner), or determined in a manner of FIFO (First in First out).

The controller 3 controls each part of the system SYS1 according to the firmware FW. The controller 3 may have a register 5. The firmware FW is previously written in the memory 4 through an interface 6. Upon the system SYS1 starting up, the firmware FW is read out from the memory 4. The controller 3 generates a control signal group CS according to the firmware FW and stores the control signal group CS in the register 5. The controller 3 is capable of performing various controls or processing data by using the control signal group CS.

For example, in the case where the external module OM is a camera module, the controller 3 receives image data from the interface circuit 1 via the bus 2. Then the controller 3 carries out image processing for the image data, and stores the processed image data in the memory 4 or the like.

Alternatively, in the case where the external module OM is a controller module, the controller 3 receives a control data from the interface circuit 1 via the bus 2. Then the controller 3 carries out a control operation (for example, control operation cooperating with a controller in the external module OM) according to a control data.

It should be noted that, as shown in FIG. 8, the system 1 including the bus 2, the interface circuit 1-1, the controller 3, the memory 4, the register 5, and the interface(I/F) 6 is mounted on a single chip CHIP 1.

In the system SYS1, a plurality of external modules OM1-OM4 can be needed to externally connect to an interface circuit 1-1. In this time, the bus standard requires to connect each of a plurality of external modules OM1-OM4 to the clock interface and the data interface. However, because the interface circuit 1-1 is provided with a single clock interface SIF, it has been significantly difficult to externally connect the plurality of external modules OM-OM4 to the interface circuit 1-1 while satisfying the bus standard. Because a single external module OM is capable of connecting to the interface circuit 1-1, the interface circuit 1-1 tends to have small degree of freedom with respect to the number of external modules externally connectable to the interface circuit 1-1.

In order to satisfying this requirement while meeting the bus standard, it is necessary to add the interface circuits as many as the lacking number of the clock interfaces CIF. For example, additional interface circuits 1-2, 1-3, 1-4 may be required. In this case, as the interface circuit 1-1 is already mounted on the chip CHIP 1, the additional interface circuits 1-2, 1-3 and 1-4 are required to be mounted on independent other chips CHIP2, CHIP3 and CHIP4, respectively. It leads increasing of a chip area as a whole of the plurality of interface circuits 1-1, 1-2, 1-3 and 1-4. As a result, it results in difficulty to implement the plurality of interface circuits 1-1, 1-2, 1-3 and 1-4 within a housing of the system SYS1 compactly.

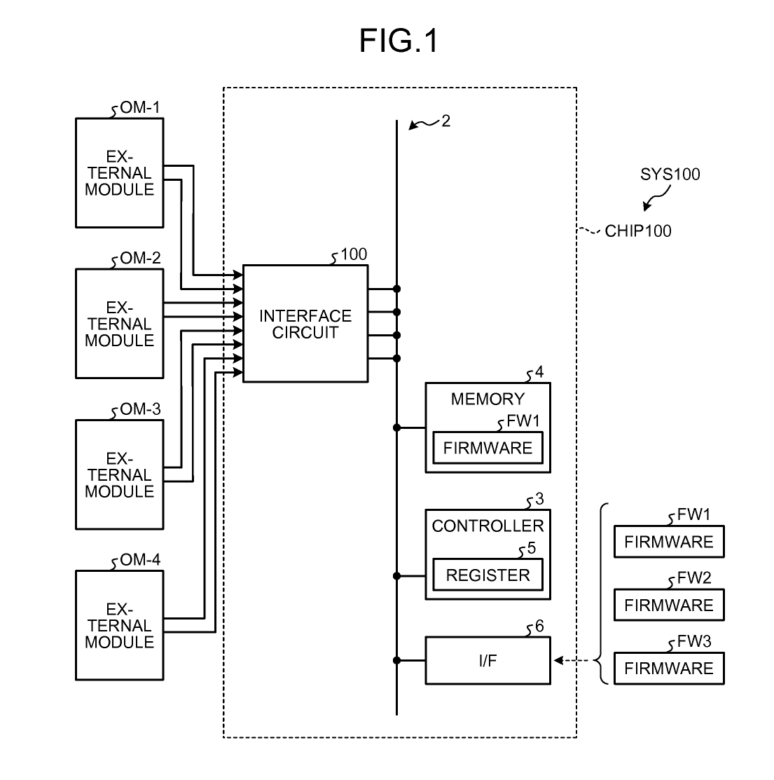

Therefore, the embodiment improves, by getting creative with arrangements of an interface circuit 100 as shown FIG. 1, degree of freedom regarding the number of the externally connectable modules while suppressing increasing of the chip area Hereinafter, portions different from the basic mode is mainly described.

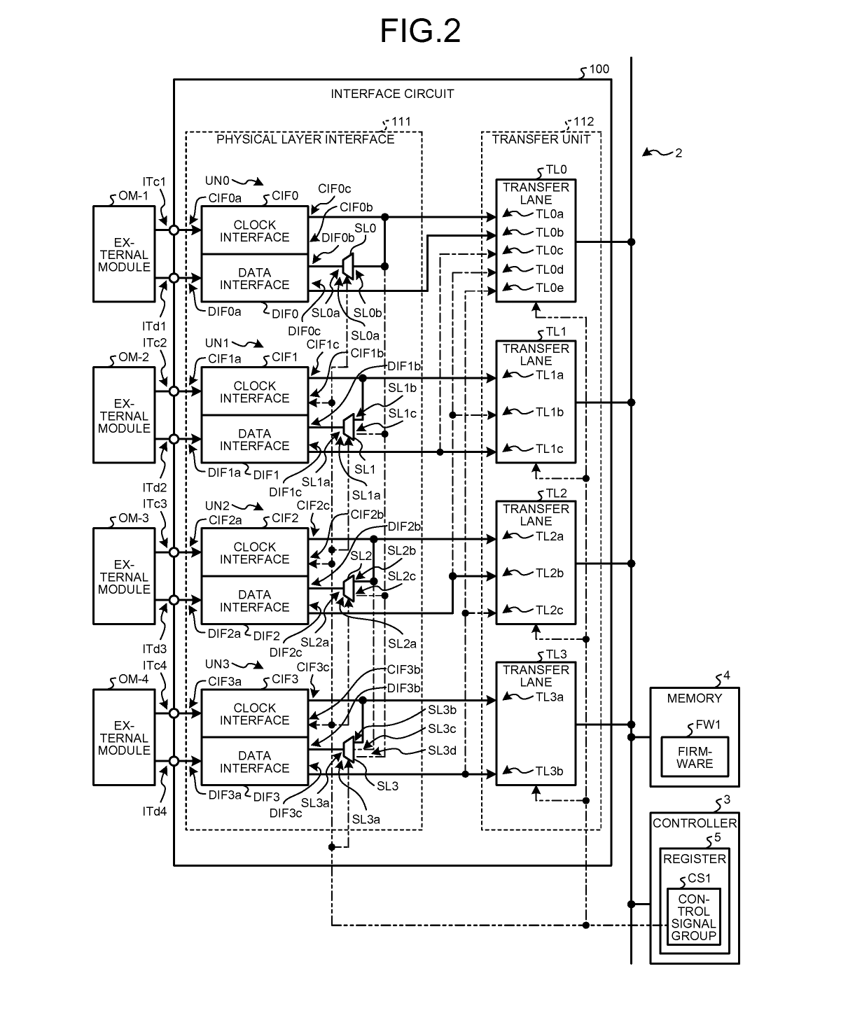

Specifically, system SYS100 is provided with a single interface circuit 100 instead of the plurality of interface circuits 1-1, 1-2, 1-3, and 1-4 (see FIG. 8). The interface circuit 100 is capable of changing internal configurations thereof according to the number of the external modules OM which are externally connected thereto (see FIGS. 2, 4, 6).

Additionally, as shown in FIG. 1, the bus 2, the interface circuit 100, the controller 3, the memory 4 and the interface (I/F) 6 in the system SYS100 are implemented on one chip CHIP100.

The interface circuit 100 includes a physical layer interface (PHY) 111 and a transfer unit 112 instead of the physical layer interface 11 and the transfer unit 12 (see FIG. 8).

The physical layer interface 111 includes a plurality of units UN0 to UN3. The transfer unit 112 includes a plurality of transfer lanes TL0 to TL3. The plurality of transfer lanes TL0 to TL3 correspond to the plurality of units UN0 to UN3.

First, a common configuration through the plurality of units UN0 to UN3 is described below.

Each of the plurality of units UN0 to UN3 includes a plurality of clock interfaces CIF0 to CIF3, a plurality of data interfaces DIF0 to DIF3, and a plurality of selectors SL0 to SL3.

The clock interfaces CIF0, CIF1, CIF2, and CIF3 include input nodes CIF0a, CIF1a, CIF2a, and CIF3a, respectively. The input nodes CIF0a, CIF1a, CIF2a, and CIF3a are connected to the input terminals ITc1, ITc2, ITc3, and ITc4, respectively. The clock interfaces CIF0, CIF1, CIF2, and CIF3 also include output nodes CIF0c, CIF1c, CIF2c, and CIF3c, respectively. The clock interfaces CIF0, CIF1, CIF2, and CIF3 also include control nodes CIF0b, CIF1b, CIF2b, and CIF3b, respectively. Each of the clock interfaces CIF0, CIF1, CIF2, and CIF3 transfers a clock upon receiving the clock at a corresponding input node of the input nodes CIF0a, CIF1a, CIF2a, and CIF3a via a corresponding input terminal of the input terminals ITc1, ITc2, ITc3, and ITc4. The clock interfaces CIF0, CIF1, CIF2, and CIF3 are capable of switching the input nodes CIF0a, CIF1a, CIF2a, and CIF3a between enable state and disable state, in response to control signals received at the control nodes CIF0b, CIF1b, CIF2b, and CIF3b, respectively.

The data interfaces DIF0, DIF1, DIF2, and DIF3 include input nodes DIF0a, DIF1a, DIF2a, and DIF3a, respectively. The input nodes DIF0a, DIF1a, DIF2a, and DIF3a are connected to the input terminals ITd1, ITd2, ITd3, and ITd4, respectively. The data interfaces DIF0, DIF1, DIF2, and DIF3 also include clock nodes DIF0b, DIF1b, DIF2b, and DIF3b, respectively. The data interfaces DIF0, DIF1, DIF2, and DIF3 also include control nodes DIF0c, DIF1c, DIF2c, and DIF3c, respectively. The data interfaces DIF0, DIF1, DIF2, and DIF3 transfer data upon receiving the data via a corresponding input terminal of the input terminals ITd1, ITd2, ITd3, and ITd4, in synchronization with clocks received at the clock nodes DIF0b, DIF1b, DIF2b, and DIF3b, respectively. The data interfaces DIF0, DIF1, DIF2, and DIF3 are capable of switching the input nodes DIF0a, DIF1a, DIF2a, and DIF3a between enable state and disable state, in response to control signals received at the control nodes DIF0c, DIF1c, DIF2c, and DIF3c, respectively.

The selectors SL0, SL1, SL2, and SL3 respectively include at least one input node. The at least one input nodes are respectively connected to at least one the output nodes CIF0c, CIF1c, CIF2c, and CIF3c of the clock interfaces CIF0, CIF1, CIF2, and CIF3. The selectors SL0, SL1, SL2, and SL3 also include output nodes SL0a, SL1a, SL2a, and SL3a, respectively. The output nodes SL0a, SL1a, SL2a, and SL3a are respectively connected to the clock nodes DIF0b, DIF1b, DIF2b, and DIF3b of the data interfaces DIF0, DIF1, DIF2, and DIF3. The selectors SL0, SL1, SL2, and SL3 also include control nodes SL0a, SL1a, SL2a, and SL3a, respectively. Each of the control nodes SL0a, SL1a, SL2a, and SL3a is connected to the controller 3 to receive a control signal from the controller 3. Each of the selectors SL0, SL1, SL2, and SL3 works and selects the clock in response to a control signal received from the controller 3 through the control nodes SL0a, SL1a, SL2a, and SL3a. Then, each of the selectors SL0, SL1, SL2, and SL3 transmits the clock to a corresponding data interface among the data interfaces DIF0, DIF1, DIF2, and DIF3. This allows the data interfaces DIF0, DIF1, DIF2, and DIF3 to transfer the data in synchronization with the clock.

Next, different portions through the plurality of units UN0 to UN3 is described below.

The clock interface CIF0 in the unit (first unit) UN0 provides output node CIF0c as being connected to a transfer lane (first transfer lane) TL0 and the input nodes of the selectors SL0 to SL3. The selector SL0 in the unit UN0 provides the input node SL0b as being connected to the output node CIF0c of the clock interface CIF0 except for the output nodes CIF1c, CIF2c, and CIF3c of the clock interfaces CIF1, CIF2, and CIF3. This allows the selector SL0 in the unit UN0 to always select the clock transferred from the clock interface CIF0 in the unit UN0 to transmit the clock to the data interface DIF0 of the unit UN0.

The clock interface CIF1 in the unit (forth unit) UN1 provides output node CIF1c as being connected to a transfer lane (forth transfer lane) TL1 and the input node SL1b of the selector SL1. The selector SL1 in the unit UN1 provides the input nodes SL1b and SL1c as being connected to the output node CIF1c of the clock interface CIF1 and the output node CIF0c of the clock interface CIF0, respectively, except for the output nodes CIF2c and CIF3c of the clock interfaces CIF2 and CIF3. This allows the selector SL1 in the unit UN1 (forth unit) to select either the clock transferred from the clock interface CIF0 in the unit UN0 (first unit) or the clock transferred from the clock interface CIF1 in the unit UN1 (forth unit) to transmit the selected clock to the data interface DIF1 of the unit UN1 (forth unit).

The clock interface CIF2 in the unit (second unit) UN2 provides output node CIF2c as being connected to a transfer lane (second transfer lane) TL2, and the selectors SL2 and SL3. The selector SL2 in the unit UN2 provides the input nodes SL2b and SL2c as being connected to the output node CIF2c of the clock interface CIF2 and the output node CIF0c of the clock interface CIF0, respectively, except for the output nodes CIF1c and CIF3c of the clock interfaces CIF1 and CIF3. This allows the selector SL2 in the unit UN2 (second unit) to select either the clock transferred from the clock interface CIF0 in the unit UN0 (first unit) or the clock transferred from the clock interface CIF2 in the unit UN2 (second unit) to transmit the selected clock to the data interface DIF2 of the unit UN2 (second unit).

The clock interface CIF3 in the unit (third unit) UN3 provides output node CIF3c as being connected to a transfer lane (third transfer lane) TL3 and the selector SL3. The selector SL3 in the unit UN3 provides the input nodes SL3b, SL3c and SL3d as being connected to the output node CIF3c of the clock interface CIF3, the output node CIF2c of the clock interface CIF2 and the output node CIF0c of the clock interface CIF0, respectively, except for the output node CIF1c of the clock interfaces CIF1. This allows the selector SL3 in the unit UN3 (third unit) to select either one of the clock transferred from the clock interface CIF0 in the unit UN0 (first unit), the clock transferred from the clock interface CIF2 in the unit UN2 (second unit), or the clock transferred from the clock interface CIF3 in the unit UN3 (third unit), to transmit the selected clock to the data interface DIF3 of the unit UN3 (third unit).

Next, switching of internal configurations of the interface circuit 100 is described below.

As shown in FIG. 1, a plural kind of firmware FW1 to FW3 are prepared in advance corresponding to the number of candidates of the external modules OM to be externally connected to the system. User can chose some of firmware according to the number of the external modules OM to be externally connected to the system to write those selected in the memory 4 through the interface 6. That is, the interface circuit 100 has a plurality of modes corresponding to the plurality of firmware FW1 to FW3. In such a plurality of modes, the internal configurations of the interface circuit 100 switches corresponding to the number of the external modules OM to be externally connected to the system.

For example, as shown in FIG. 2, when it is desired to externally connect four external modules OM-1, OM-2, OM-3, and OM-4 to the system, firmware FW1 is selected so as to be written in the memory 4 through the interface 6 (see FIG. 1). FIG. 2 is a schematic diagram of one example of a circuit configuration of the interface circuit 100 according to the embodiment when firmware FW1 is selected. Upon the system SYS100 starting up, the controller 3 reads the firmware FW1 from the memory 4 to store a group of control signals CS1 according to the firmware FW1 in the register 5. In response to the group of control signals CS1, the controller 3 controls the interface circuit 100, so that the interface circuit 100 is arranged in such a manner that four external modules OM-1, OM-2, OM-3, and OM-4 are capable of being externally connected to the system. For example, the controller 3 controls the interface circuit 100 such that the solid line depicted in FIG. 2 is activated while the broken line depicted in FIG. 2 is non-activated. In this case, the interface circuit 100 works in the first mode corresponding to the firmware FW1.

Specifically, the selector SL0 selects the input node SL0b from among input nodes consisting of the input node SL0b and other input nodes (not shown) in response to a control signal from the controller 3 according to the firmware FW1. This allows the selector SL0 in the unit UN0 to select the clock transferred from the clock interface CIF0 in the unit UN0 to transmit the clock to the data interface DIF0 of the unit UN0 via the output node SL0a.

The selector SL1 selects the input node SL1b from among input nodes consisting of the input node SL1b and the input node SL1c in response to a control signal from the controller 3 according to the firmware FW1. This allows the selector SL1 in the unit UN1 to select the clock transferred from the clock interface CIF1 in the unit UN1 to transmit the clock to the data interface DIF1 of the unit UN1 via the output node SL1a. For example, the selector SL1 causes the input node SL1c to be high impedance and causes the broken line portion of lines connected to the clock interface CIF0 to non-activate.

The selector SL2 selects the input node SL2b from among input nodes consisting of the input node SL2b and the input node SL2c in response to a control signal from the controller 3 according to the firmware FW1. This allows the selector SL2 in the unit UN2 to select the clock transferred from the clock interface CIF2 in the unit UN2 to transmit the clock to the data interface DIF2 of the unit UN2 via the output node SL2a. For example, the selector SL2 causes the input node SL2c to be high impedance and causes the broken line portion of lines connected to the clock interface CIF0 to non-activate.

The selector SL3 selects the input node SL3b from among input nodes consisting of the input nodes SL2b, SL2c, and SL2d in response to a control signal from the controller 3 according to the firmware FW1. This allows the selector SL3 in the unit UN3 to select the clock transferred from the clock interface CIF3 in the unit UN3 to transmit the clock to the data interface DIF3 of the unit UN3 via the output node SL3a. For example, the selector SL3 causes the input node SL3c to be high impedance and causes the broken line portion of lines connected to the clock interface CIF2 to non-activate. The selector SL3 also causes the input node SL3d to be high impedance and causes the broken line portion of lines connected to the clock interface CIF0 to non-activate.

The transfer lane TL0 causes the input node TL0a connected to the clock interface CIF0 and the input node TL0b connected to the data interface DIF0 to enable in response to a control signal from the controller 3 according to the firmware FW1. The transfer lane TL0 causes the input nodes TL0c, TL0d, and TL0e respectively connected to the data interfaces DIF1, DIF2, and DIF3 to disable in response to a control signal from the controller 3 according to the firmware FW1. For example, the transfer lane TL0 causes the input nodes TL0c, TL0d, and TL0e to be high impedance and causes the broken line portion of lines connected to the data interfaces DIF1, DIF2, and DIF3 to non-activate.

The transfer lane TL1 causes the input node TL1a connected to the clock interface CIF1 and the input node TL1c connected to the data interface DIF1 to enable in response to a control signal from the controller 3 according to the firmware FW1. The transfer lane TL1 causes the input node TL1b connected to the data interface DIF2 to be disable in response to a control signal from the controller 3 according to the firmware FW1. For example, the transfer lane TL1 causes the input node TL1b to be high impedance and causes the broken line portion of lines connected to the data interface DIF2 to non-activate.

The transfer lane TL2 causes the input node TL2a connected to the clock interface CIF2 and the input node TL2b connected to the data interface DIF2 to enable in response to a control signal from the controller 3 according to the firmware FW1. The transfer lane TL2 causes the input node TL2c connected to the data interface DIF3 to be disable in response to a control signal from the controller 3 according to the firmware FW1. For example, the transfer lane TL2 causes the input node TL2c to be high impedance and causes the broken line portion of lines connected to the data interface DIF3 to non-activate.

The transfer lane TL3 causes the input node TL3a connected to the clock interface CIF3 and the input node TL3b connected to the data interface DIF3 to enable in response to a control signal from the controller 3 according to the firmware FW1.

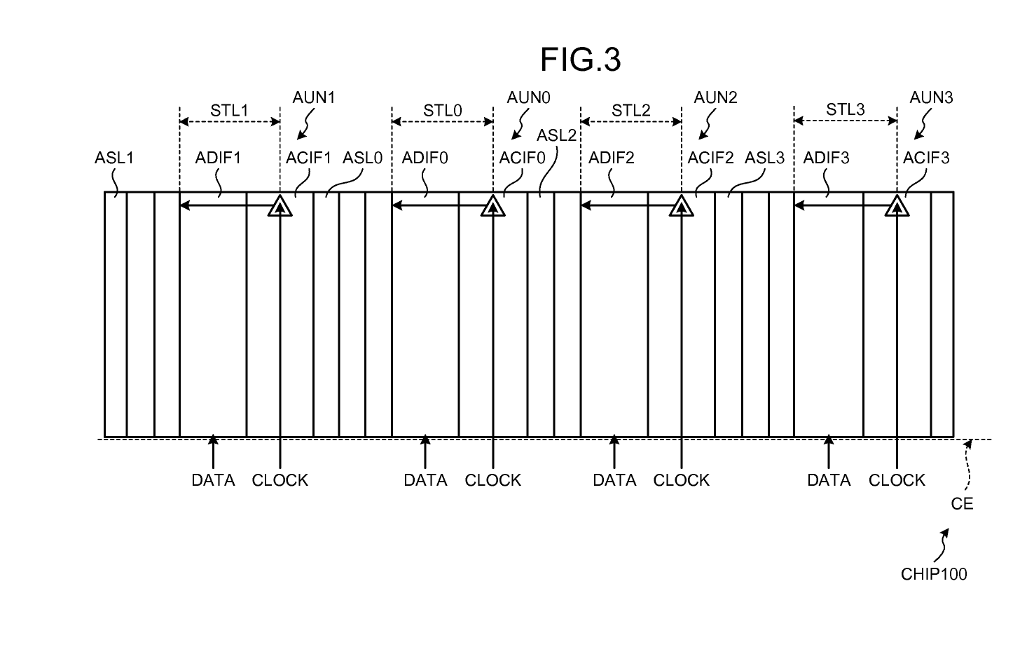

In this case, a layout of a plurality of the units UN0 to UN3 may be arranged as shown in FIG. 3. FIG. 3 is a schematic diagram of one example of a configuration of layout and a clock transmission path of a plurality of units of an interface circuit according to an embodiment when firmware FW1 is selected.

As shown in FIG. 3, the plurality of the units UN0 to UN3 may be positioned at unit arrangement areas AUN0, AUN1, AUN2, and AUN3, respectively. The plurality of the units UN0 to UN3 may be disposed in the vicinity of a chip edge CE on the chip CHIP100. The unit arrangement areas AUN0, AUN1, AUN2, and AUN3 may be arranged in a direction along the chip edge CE in the vicinity of the chip edge CE. For example, as shown in FIG. 3, the unit arrangement areas AUN1, AUN0, AUN2, and AUN3 may be arranged in this order from left to right along with the chip edge CE of FIG. 3. In this arrangement, units UN0 and UN2 are adjacently positioned at near center of a line along the chip edge CE. Furthermore both units UN0 and UN2 are sandwiched between units UN1 and UN3 along the chip edge CE.

In each of the unit arrangement areas AUN1, AUN0, AUN2, and AUN3, data interface arrangement areas ADIF0 to ADIF3 are sandwiched between clock interface arrangement areas ACIF0 to ACIF3 and selector arrangement areas ASL0 to ASL3, respectively. The clock interfaces CIF0 to CIF3 (see FIG. 2) are positioned in the clock interface arrangement areas ACIF0 to ACIF3, respectively. The data interfaces DIF0 to DIF3 (see FIG. 2) are positioned in the data interface arrangement areas ADIF0 to ADIF3. The selectors SL0 to SL3 (see FIG. 2) are positioned in the selector arrangement areas ASL0 to ASL3. The data interface arrangement areas ADIF0 to ADIF3 are sandwiched between the selector arrangement areas ASL0 to ASL3 and the clock interface arrangement areas ACIF0 to ACIF3, respectively, along the chip edge CE. It is possible to obtain a layout having a plurality of units UN0 to UN3 each of which includes a similar arrangement in this manner.

FIG. 3 also illustrates a schematically diagram of transition path of clock depicted with arrows in a situation where the internal configuration of the interface circuit 100 is switched as shown in FIG. 2. In practice, the clock is not necessarily transmitted in plane and in line. In view of simplicity, transmission paths are depicted in lines with arrows in a direction linearly approximated and projected on a predetermined plane (e.g., a surface of a semiconductor substrate). In FIG. 3, notation Δ denotes a node that the transmission path of the clock branches.

For example, clocks from the external modules are respectively input to the clock interfaces CIF0 to CIF3 arranged in the clock interface arrangement areas ACIF0 to ACIF3. Also, clocks transferred from the clock interfaces CIF0 to CIF3 are output to the transfer lanes TL0 to TL3 (see FIG. 2). The clocks output from the clock interfaces CIF0 to CIF3 (see FIG. 2) are output to the data interfaces DIF0 to DIF3 (see FIG. 2) arranged in the data interface arrangement areas ADIF0 to ADIF3 through the selectors SL0 to SL3 (see FIG. 2) arranged in the selector arrangement areas ASL0 to ASL3.

In this case, it is possible for the unit arrangement areas AUN0 to AUN3 to provide transmission paths (wirings) of clock as each lengths STL0 to STL3 thereof being substantially equivalent in a direction along the chip edge CE because a layout in each unit arrangement areas AUN0 to AUN3, a layout of each units UN0 to UN3, is similar to each other. This allows the units UN0 to UN3 to be easily provided with uniform characteristics (e.g., transmission time delay).

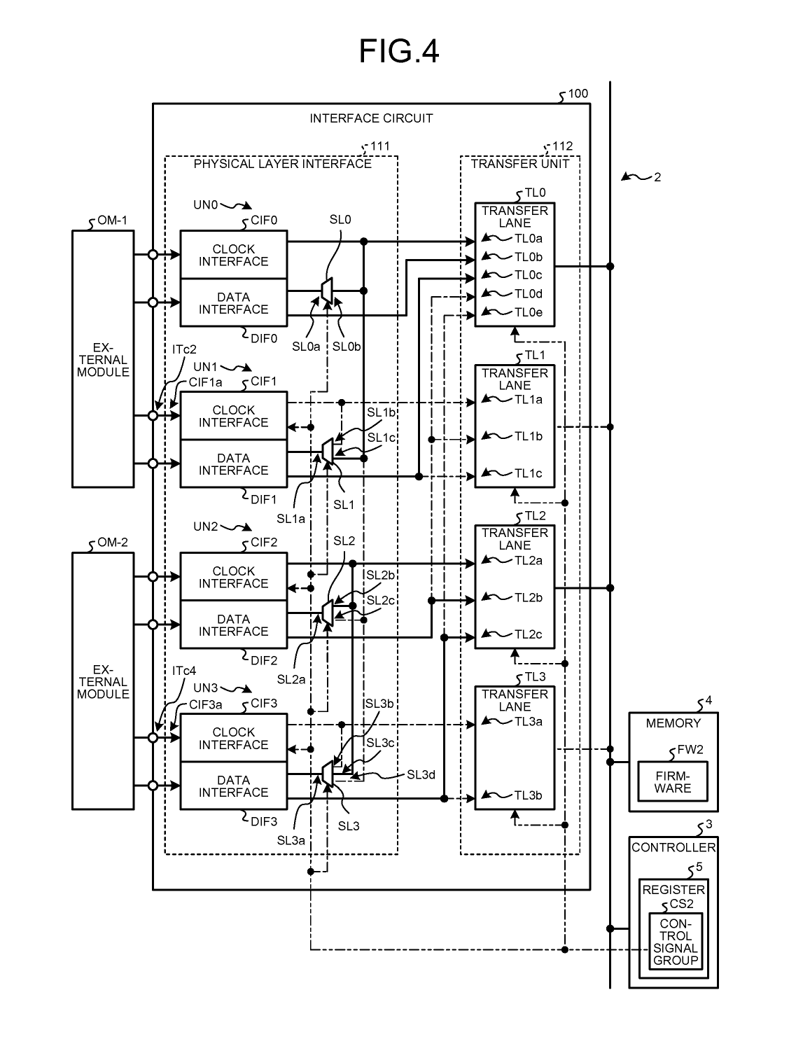

Alternatively, for example, as shown in FIG. 4, when it is desired to connect two external modules OM-1 and OM-2 to the interface circuit 100, firmware FW2 is selected and then the firmware FW2 is written in the memory 4 via the interface 6 (see FIG. 1). FIG. 4 is a schematic diagram of one example of a circuit configuration of an interface circuit according to an embodiment when firmware FW2 is selected. Upon the system SYS100 starting up, the controller 3 reads firmware FW2 from the memory 4 and generates a control signal group CS according to the firmware FW2 and stores the control signal group CS in the register 5. The controller 3 is capable of controlling the interface circuit 100 so as to switch the configurations of the interface circuit 100 with two external modules GM-1 and OM-2 being connected thereto, according to the control signal group CS stored in the register 5. For example, the controller 3 controls the interface circuit 100 such that the solid line depicted in FIG. 4 is activated while the broken line depicted in FIG. 4 is non-activated. In this case, the interface circuit 100 works in the second mode corresponding to the firmware FW2.

Specifically, the selector SL0 selects the input node SL0b from among input nodes consisting of the input node SL0b and other input nodes (not shown) in response to a control signal from the controller 3 according to the firmware FW2. This allows the selector SL0 in the unit UN0 to select the clock transferred from the clock interface CIF0 in the unit UN0 to transmit the clock to the data interface DIF0 of the unit UN0 via the output node SL0a.

The selector SL1 selects the input node SL1c from among input nodes consisting of the input node SL1b and the input node SL1c in response to a control signal from the controller 3 according to the firmware FW2. This allows the selector SL1 in the unit UN1 to select the clock transferred from the clock interface CIF0 in the unit UN0 to transmit the clock to the data interface DIF1 of the unit UN1 via the output node SL1a. For example, the selector SL1 causes the input node SL1b to be high impedance and causes the broken line portion of lines connected to the clock interface CIF1 to non-activate.

The selector SL2 selects the input node SL2b from among input nodes consisting of the input node SL2b and the input node SL2c in response to a control signal from the controller 3 according to the firmware FW2. This allows the selector SL2 in the unit UN2 to select the clock transferred from the clock interface CIF2 in the unit UN2 to transmit the clock to the data interface DIF2 of the unit UN2 via the output node SL2a. For example, the selector SL2 causes the input node SL2c to be high impedance and causes the broken line portion of lines connected to the clock interface CIF0 to non-activate.

The selector SL3 selects the input node SL3c from among input nodes consisting of the input nodes SL2b, SL2c, and SL2d in response to a control signal from the controller 3 according to the firmware FW2. This allows the selector SL3 in the unit UN3 to select the clock transferred from the clock interface CIF2 in the unit UN2 to transmit the clock to the data interface DIF3 of the unit UN3 via the output node SL3a. For example, the selector SL3 causes the input node SL3b to be high impedance and causes the broken line portion of lines connected to the clock interface CIF3 to non-activate. The selector SL3 also causes the input node SL3d to be high impedance and causes the broken line portion of lines connected to the clock interface CIF0 to non-activate.

The clock interface CIF1 causes the input node CIF1a to disable in response to a control signal from the controller 3 according to the firmware FW2. For example, the clock interface CIF1 causes the input node CIF1a to be high impedance and causes the input terminal ITc2 and the line connected to the input terminal ITc2 to non-activate.

The clock interface CIF3 causes the input node CIF3a to disable in response to a control signal from the controller 3 according to the firmware FW2. For example, the clock interface CIF3 causes the input node CIF3a to be high impedance and causes the input terminal ITc4 and the line connected to the input terminal ITc4 to non-activate.

The transfer lane TL0 causes the input node TL0a connected to the clock interface CIF0 and the input nodes TL0b, TL0c connected respectively to the data interfaces DIF0, DIF1 to enable in response to a control signal from the controller 3 according to the firmware FW2. The transfer lane TL0 causes the input nodes TL0d and TL0e respectively connected to the data interfaces DIF2 and DIF3 to disable in response to a control signal from the controller 3 according to the firmware FW2. For example, the transfer lane TL0 causes the input nodes TL0d and TL0e to be high impedance and causes the broken line portion of lines connected to the data interfaces DIF2 and DIF3 to non-activate.

The transfer lane TL1 causes the input node TL1a connected to the clock interface CIF1 and the input nodes TL1b and TL1c respectively connected to the data interfaces DIF1 and DIF2 to disable in response to a control signal from the controller 3 according to the firmware FW2. For example, the transfer lane TL1 causes the input node TL1a to be high impedance and causes the broken line portion of lines connected to the clock interface CIF1 to non-activate. The transfer lane TL1 causes the input node TL1b and TL1c to be high impedance and causes the broken line portion of lines connected to the data interfaces DIF1 and DIF2 to non-activate.

The transfer lane TL2 causes the input node TL2a connected to the clock interface CIF2 and the input node TL2b and TL2c respectively connected to the data interface DIF2 and DIF3 to enable in response to a control signal from the controller 3 according to the firmware FW2.

The transfer lane TL3 causes the input node TL3a connected to the clock interface CIF3 and the input node TL3b connected to the data interface DIF3 to disable in response to a control signal from the controller 3 according to the firmware FW2. For example, the transfer lane TL3 causes the input node TL3a to be high impedance and causes the broken line portion of lines connected to the clock interface CIF3 to non-activate. The transfer lane TL3 causes the input node TL3b to be high impedance and causes the broken line portion of lines connected to the data interface DIF3 to non-activate.

According to the interface circuit 100, it is easily possible to improve data transfer rate by providing two data interfaces (data lanes) for the external modules OM-1 and OM-2.

In the interface circuit 100, clocks of the clock interfaces CIF0 and CIF2 are selected and clocks of the clock interfaces CIF1 and CIF3 are not selected. Comparing FIG. 2 and FIG. 4, in the interface circuit 100, there is the following relationship between selection priorities of clock from the clock interfaces.

(Selection priority of clock from the clock interfaces CIF0 and CIF2)>(selection priority of clock from the clock interfaces CIF1 and CIF3) formula 1

Here, the term “selection priority of clock” is defined as an index for determining a clock from which clock interface to be selected when the number of the external modules OM externally connected to the system through the interface circuit 100 is changed. For example, when four external modules OM are externally connected to the system through the interface circuit 100 as shown in FIG. 2, and when two external modules OM are externally connected to the system through the interface circuit 100 as shown in FIG. 4, clocks from the clock interfaces CIF0 and CIF2 are selected in both cases. On the other hand, when four external modules OM are externally connected to the system through the interface circuit 100 as shown in FIG. 2, clocks from the clock interfaces CIF1 and CIF3 are selected, but when two external modules OM are externally connected to the system through the interface circuit 100 as shown in FIG. 4, clocks from the clock interfaces CIF1 and CIF3 are not selected by any selector. Thus, it means that the above described relationship indicated by formula 1 is established and satisfied.

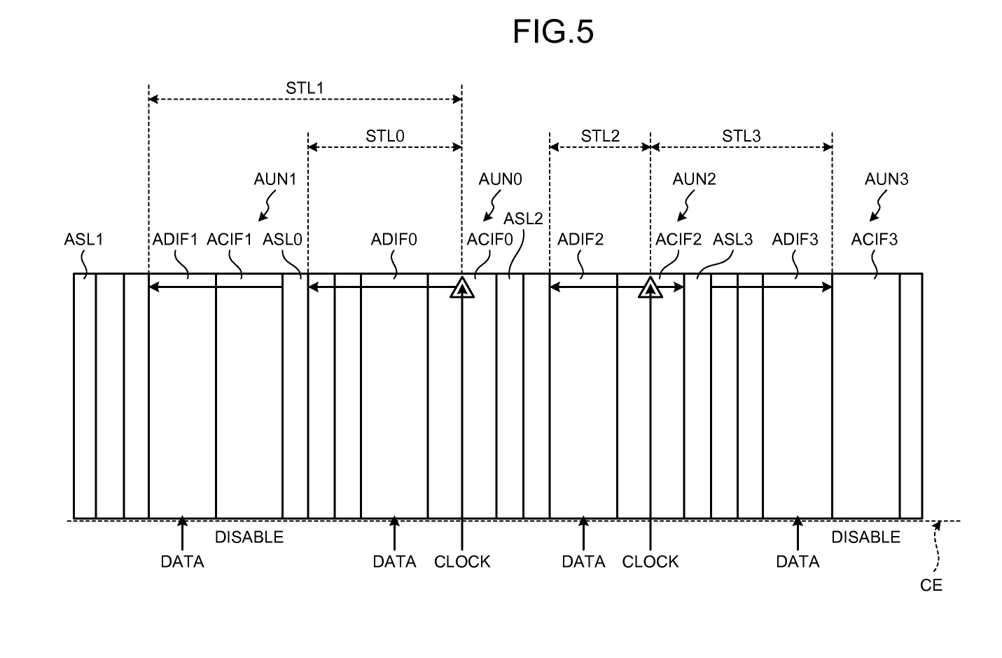

FIG. 5 is a schematic diagram of one example of a configuration of layout and a clock transmission path of a plurality of units of an interface circuit according to an embodiment when firmware FW2 is selected. FIG. 5 also illustrates a schematically diagram of transition path of clock depicted with arrows in a situation where the internal configuration of the interface circuit 100 is switched as shown in FIG. 4. In view of simplicity, transmission paths are depicted in lines with arrows in a direction linearly approximated and projected on a predetermined plane (e.g., a surface of a semiconductor substrate). In FIG. 5, notation Δ denotes a node that the transmission path of the clock branches.

For example, clocks from the external modules are respectively input to the clock interfaces CIF0 and CIF2 arranged in the clock interface arrangement areas ACIF0 and ACIF2. Also, clock transferred from the clock interfaces CIF0 is output to the transfer lane TL0 (see FIG. 4). The clock output from the clock interface CIF0 is output to the data interfaces DIF0 and DIF1 (see FIG. 4) arranged in the data interface arrangement areas ADIF0 and ADIF1 through the selectors SL0 and SL1 (see FIG. 4) arranged in the selector arrangement areas ASL0 and ASL1. Also, clock transferred from the clock interfaces CIF2 is output to the transfer lane TL2 (see FIG. 4). The clock output from the clock interface CIF2 is output to the data interfaces DIF2 and DIF3 (see FIG. 4) arranged in the data interface arrangement areas ADIF2 and ADIF3 through the selectors SL2 and SL3 (see FIG. 4) arranged in the selector arrangement areas ASL2 and ASL3.

In this arrangement, unit arrangement areas AUN0 and AUN2 are adjacently positioned at near center of a line along the chip edge CE. Furthermore both unit arrangement areas AUN0 and AUN2 are sandwiched between unit arrangement areas AUN1 and AUN3 along the chip edge CE. That is, a location of units UN0 and UN2 including clock interfaces CIF0 and CIF2 that transfer the clock having higher priority is closer to the center of the line along the chip edge CE than a location of units UN1 and UN3 including clock interfaces CIF1 and CIF3 that transfer the clock having lower priority. In this case, it is possible for at least the units UN0, UN2 and UN3 to provide transmission paths (wirings) of clock as each length STL0, STL2 and STL3 thereof being substantially equivalent in a direction along the chip edge CE. Furthermore, it is possible to suppress, within a range of one unit, a difference between each transmission paths length STL0, STL2 and STL3 of the units UN0, UN2 and UN3, and transmission path length STL1 of the unit UN1. This allows the units UN0 to UN3 to be easily provided with uniform characteristics (e.g., transmission time delay).

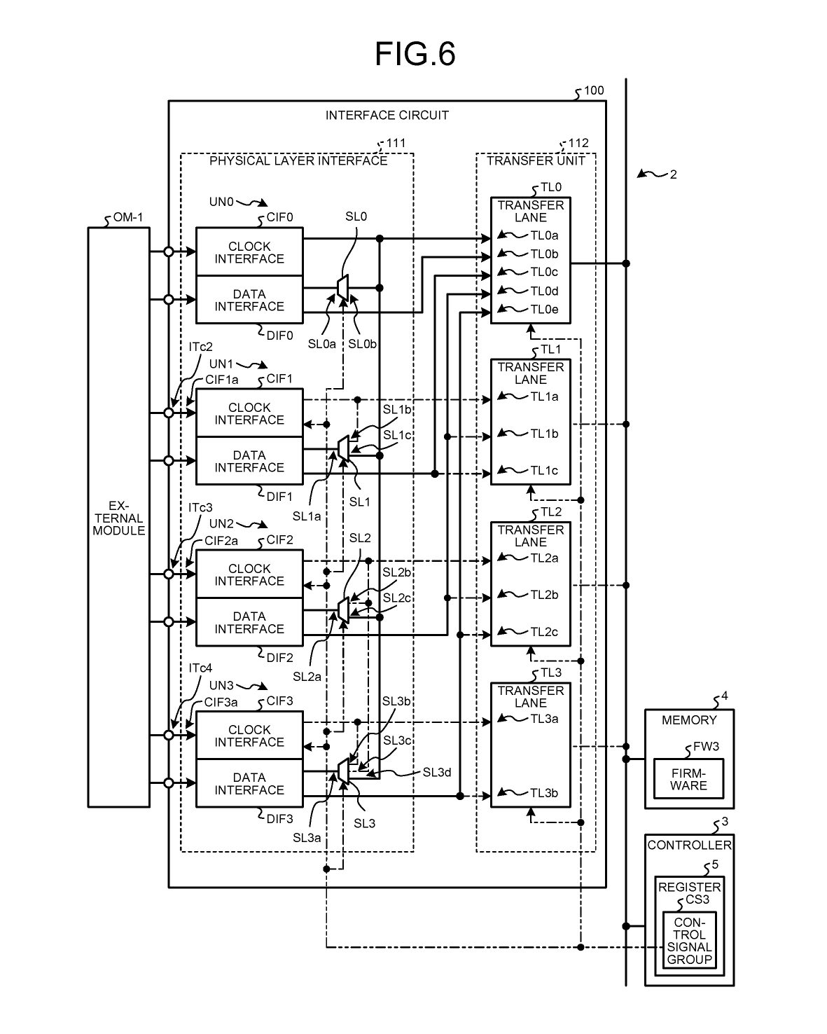

Alternatively, for example, as shown in FIG. 6, when it is desired to connect one external module OM-1 to the interface circuit 100, firmware FW3 is selected and then the firmware FW3 is written in the memory 4 via the interface 6 (see FIG. 1). FIG. 6 is a schematic diagram of one example of a circuit configuration of an interface circuit according to an embodiment when firmware FW3 is selected. Upon the system SYS100 starting up, the controller 3 reads firmware FW3 from the memory 4 and generates a control signal group CS according to the firmware FW3 and stores the control signal group CS in the register 5. The controller 3 is capable of controlling the interface circuit 100 so as to switch the configurations of the interface circuit 100 with one external module OM-1 being connected thereto, according to the control signal group CS stored in the register 5. For example, the controller 3 controls the interface circuit 100 such that the solid line depicted in FIG. 6 is activated while the broken line depicted in FIG. 6 is non-activated. In this case, the interface circuit 100 works in the third mode corresponding to the firmware FW3.

Specifically, the selector SL0 selects the input node SL0b from among input nodes consisting of the input node SL0b and other input nodes (not shown) in response to a control signal from the controller 3 according to the firmware FW3. This allows the selector SL0 in the unit UN0 to select the clock transferred from the clock interface CIF0 in the unit UN0 to transmit the clock to the data interface DIF0 of the unit UN0 via the output node SL0a.

The selector SL1 selects the input node SL1c from among input nodes consisting of the input node SL1b and the input node SL1c in response to a control signal from the controller 3 according to the firmware FW3. This allows the selector SL1 in the unit UN1 to select the clock transferred from the clock interface CIF0 in the unit UN0 to transmit the clock to the data interface DIF1 of the unit UN1 via the output node SL1a. For example, the selector SL1 causes the input node SL1b to be high impedance and causes the broken line portion of lines connected to the clock interface CIF1 to non-activate.

The selector SL2 selects the input node SL2c from among input nodes consisting of the input node SL2b and the input node SL2c in response to a control signal from the controller 3 according to the firmware FW3. This allows the selector SL2 in the unit UN2 to select the clock transferred from the clock interface CIF0 in the unit UN0 to transmit the clock to the data interface DIF2 of the unit UN2 via the output node SL2a. For example, the selector SL2 causes the input node SL2b to be high impedance and causes the broken line portion of lines connected to the clock interface CIF2 to non-activate.

The selector SL3 selects the input node SL3d from among input nodes consisting of the input nodes SL3b, SL3c, and SL3d in response to a control signal from the controller 3 according to the firmware FW3. This allows the selector SL3 in the unit UN3 to select the clock transferred from the clock interface CIF0 in the unit UN0 to transmit the clock to the data interface DIF3 of the unit UN3 via the output node SL3a. For example, the selector SL3 causes the input node SL3b to be high impedance and causes the broken line portion of lines connected to the clock interface CIF3 to non-activate. The selector SL3 also causes the input node SL3c to be high impedance and causes the broken line portion of lines connected to the clock interface CIF2 to non-activate.

The clock interface CIF1 causes the input node CIF1a to disable in response to a control signal from the controller 3 according to the firmware FW3. For example, the clock interface CIF1 causes the input node CIF1a to be high impedance and causes the input terminal ITc2 and the line connected to the input terminal ITc2 to non-activate.

The clock interface CIF2 causes the input node CIF2a to disable in response to a control signal from the controller 3 according to the firmware FW3. For example, the clock interface CIF2 causes the input node CIF2a to be high impedance and causes the input terminal ITc3 and the line connected to the input terminal ITc3 to non-activate.

The clock interface CIF3 causes the input node CIF3a to disable in response to a control signal from the controller 3 according to the firmware FW3. For example, the clock interface CIF3 causes the input node CIF3a to be high impedance and causes the input terminal ITc4 and the line connected to the input terminal ITc4 to non-activate.

The transfer lane TL0 causes the input node TL0a connected to the clock interface CIF0 and the input nodes TL0b-TL0e connected respectively to the data interfaces DIF0 to DIF3 to enable in response to a control signal from the controller 3 according to the firmware FW3.

The transfer lane TL1 causes the input node TL1a connected to the clock interface CIF1 and the input nodes TL1b and TL1c respectively connected to the data interfaces DIF1 and DIF2 to disable in response to a control signal from the controller 3 according to the firmware FW3. For example, the transfer lane TL1 causes the input node TL1a to be high impedance and causes the broken line portion of lines connected to the clock interface CIF1 to non-activate. The transfer lane TL1 causes the input node TL1b and TL1c to be high impedance and causes the broken line portion of lines connected to the data interfaces DIF1 and DIF2 to non-activate.

The transfer lane TL2 causes the input node TL2a connected to the clock interface CIF2 and the input node TL2b and TL2c respectively connected to the data interface DIF2 and DIF3 to disable in response to a control signal from the controller 3 according to the firmware FW3. For example, the transfer lane TL2 causes the input node TL2a to be high impedance and causes the broken line portion of lines connected to the clock interface CIF1 to non-activate. The transfer lane TL2 causes the input nodes TL2b and TL2c to be high impedance and causes the broken line portion of lines connected to the data interfaces DIF2 and DIF3 to non-activate.

The transfer lane TL3 causes the input node TL3a connected to the clock interface CIF3 and the input node TL3b connected to the data interface DIF3 to disable in response to a control signal from the controller 3 according to the firmware FW3. For example, the transfer lane TL3 causes the input node TL3a to be high impedance and causes the broken line portion of lines connected to the clock interface CIF1 to non-activate. The transfer lane TL3 causes the input node TL3b to be high impedance and causes the broken line portion of lines connected to the data interface DIF3 to non-activate.

According to the interface circuit 100, it is easily possible to improve data transfer rate by providing four data interfaces (data lanes) for the external module OM-1.

In the interface circuit 100, clock of the clock interface CIF0 is selected and clocks of the clock interfaces CIF1-CIF3 are not selected. Comparing FIG. 2, FIG. 4 and FIG. 6, in the interface circuit 100, there is the following relationship between selection priorities of clock from the clock interfaces.

(Selection priority of clock from the clock interfaces CIF0)>(selection priority of clock from the clock interfaces CIF2)>(selection priority of clock from the clock interfaces CIF1 and CIF3) formula 2

Here, the term “selection priority of clock” is defined as an index for determining a clock from which clock interface to be selected when the number of the external modules OM externally connected to the system through the interface circuit 100 is changed. For example, when four external modules OM are externally connected to the system through the interface circuit 100 as shown in FIG. 2, when two external modules OM are externally connected to the system through the interface circuit 100 as shown in FIG. 4, and when one external module OM is externally connected to the system through the interface circuit 100 as shown in FIG. 6, the clock from the clock interfaces CIF0 is selected in all cases. On the other hand, when four external modules OM are externally connected to the system through the interface circuit 100 as shown in FIG. 2, and when two external modules OM are externally connected to the system through the interface circuit 100 as shown in FIG. 4, the clock from the clock interfaces CIF2 are selected in both cases, but when one external module OM is externally connected to the system through the interface circuit 100 as shown in FIG. 6, any clocks from any clock interfaces CIF0 to CIF3 are not selected by any selector. Thus, it means that the above described relationship indicated by formula 2 is established and satisfied.

It means that the clock with high priority is likely selected by the selectors of the units even if the number of external module OM externally connected to the system through the interface circuit 100 is changed.

Here, it is preferable for the interface circuit 100 to reduce the number of the clock interfaces that transfer clocks because it leads to less power consumption of the interface circuit 100. However, when a plurality of external modules OM are externally connected to the interface circuit 100, the plurality of external modules OM may supply different frequency of clock signals to the interface circuit 100. In this case, if data transmitted from an external module OM is transferred with a clock transmitted from another external module OM, transmission errors such as data deformation may happen due to a wrong timing data transfer. Thus, in order to prevent from happening transmission errors, data should be transferred with the clock that is transmitted from an external module OM from which the data is transmitted. In order to decrease the number of the clock interfaces as possible under the restriction, “selection priority of clock” is introduced in the embodiment, the selectors are controlled based on the index of “selection priority of clock.”

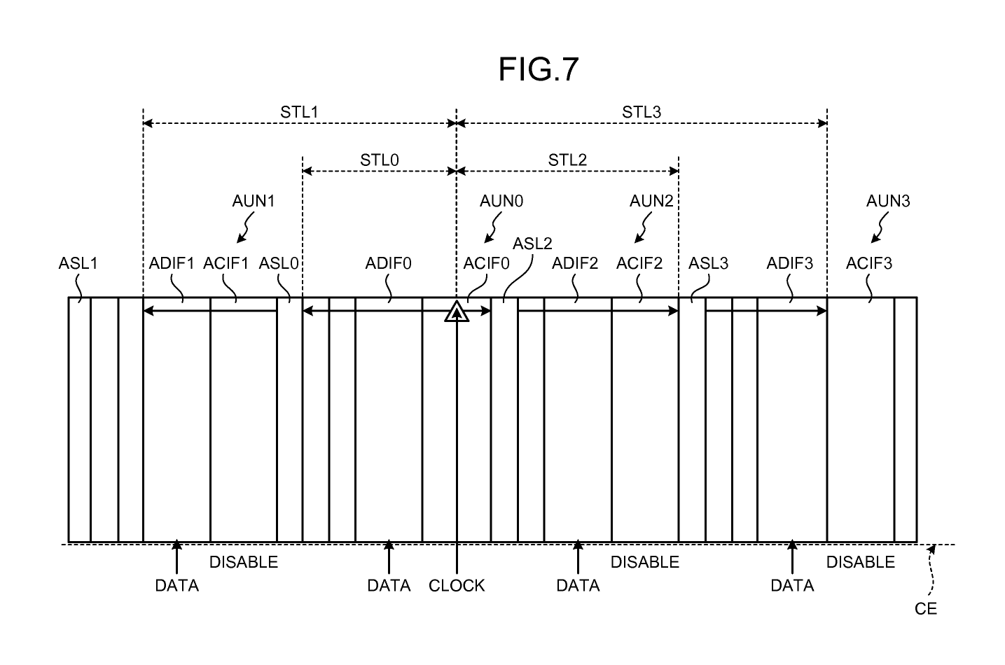

FIG. 7 is a schematic diagram of one example of a configuration of layout and a clock transmission path of a plurality of units of an interface circuit according to an embodiment when firmware FW3 is selected. FIG. 7 also illustrates a schematically diagram of transition path of clock depicted with arrows in a situation where the internal configuration of the interface circuit 100 is switched as shown in FIG. 6. In view of simplicity, transmission paths are depicted in lines with arrows in a direction linearly approximated and projected on a predetermined plane (e.g., a surface of a semiconductor substrate). In FIG. 7, notation Δ denotes a node that the transmission path of the clock branches.

For example, clock from the external module is input to the clock interface CIF0 arranged in the clock interface arrangement areas ACIF0. Also, clock transferred from the clock interface CIF0 is output to the transfer lane TL0 (see FIG. 6). The clock output from the clock interface CIF0 is output to the data interfaces DIF0 to DIF3 (see FIG. 6) arranged in the data interface arrangement areas ADIF0 to ADIF3 through the selectors SL0 to SL3 (see FIG. 6) arranged in the selector arrangement areas ASL0 to ASL3.

In this arrangement, unit arrangement areas AUN0 and AUN2 are adjacently positioned at near center of a line along the chip edge CE. Furthermore both unit arrangement areas AUN0 and AUN2 are sandwiched between unit arrangement areas AUN1 and AUN3 along the chip edge CE. That is, a location of units UN0 and UN2 including clock interfaces CIF0 and CIF2 that transfer the clock having higher priority is closer to the center of the line along the chip edge CE than a location of units UN1 and UN3 including clock interfaces CIF1 and CIF3 that transfer the clock having lower priority. In this case, it is possible for at least the units UN0 and UN2 to provide transmission paths (wirings) of clock as each length STL0 and STL2 thereof being substantially equivalent in a direction along the chip edge CE. It is also possible for at least the units UN1 and UN3 to provide transmission paths (wirings) of clock as each length STL1 and STL3 thereof being substantially equivalent in a direction along the chip edge CE. Furthermore, it is possible to suppress a difference between transmission path length STL0, STL2 and transmission path length STL1, STL3 within a range of one unit. This allows the units UN0 to UN3 to be easily provided with uniform characteristics (e.g., transmission time delay).

As described above, according to the embodiment, in the interface circuit 100, Each of a plurality of units UN0 to UN3, includes a clock interface CIF0 to CIF3, a data interface DIF0 to DIF3, and a selector SL0 to SL3, respectively. The selector SL0 to SL3 selects the clock to supply the clock to the data interface DIF0 to DIF3 such that the data interface DIF0 to DIF3 transfers the data in synchronization with the clock. This allows the interface circuit 100 to switch internal configurations thereof according to the number of the external modules OM to be externally connected thereto. Thus, because a plurality of external modules OM-1, OM-2, OM-3, and OM-4 can be externally connectable to the interface circuit 100 without adding another chips CHIP2 to CHIP4 (see FIG. 8), it is possible to increase the degree of freedom of the number of externally connectable modules while suppressing the increase of the chip area.

According to the embodiment, in the plurality of units UN0 to UN3 of the interface circuit 100, a selector SL0 of a unit UN0 always selects a clock transferred from a clock interface CIF0 of the unit UN0 to supply the clock to a data interface DIF0 of the unit UN0. Selectors SL1, SL2 of units UN1, UN2 selects either the clock transferred from the clock interface CIF0 of the unit UN0 or a clock transferred from clock interfaces CIF1, CIF2 of the units UN1, UN2 to supply the selected clock to data interfaces DIF1, DIF2 of the units UN1, UN2. A selector SL3 of unit UN3 selects either one of a clock transferred from the clock interface CIF0 of the unit UN0, a clock transferred from a clock interface CIF2 of the units UN2, or a clock transferred from a clock interface CIF3 of the unit UN3 to supply the selected clock to a data interface DIF3 of the unit UN3. This allows the interface circuit 100 to switch an internal configuration thereof according to the number of the external modules OM to be externally connected thereto.

According to the embodiment, in the interface circuit 100, an arranged location of a unit including a clock interface that transfers a clock selected in a higher priority is closer to a center of a line along a chip edge than an arranged location of a unit including a clock interface that transfers a clock selected in a lower priority. For example, an arranged location of a unit UN0 is closer to a center of a line along a chip edge than an arranged location of unit UN2. For example, an arranged location of a unit UN0 is closer to a center of a line along a chip edge than arranged locations of units UN1, UN3. For example, an arranged location of a unit UN2 is closer to a center of a line along a chip edge than arranged locations of units UN1, UN3. Even if the number of external modules externally connected to the interface circuit 100 is changed, it is possible for at least the units UN0, UN2 and UN3 to provide transmission paths (wirings) of clock as each length STL0, STL2 and STL3 thereof being substantially equivalent in a direction along the chip edge CE. Furthermore, it is possible to suppress, within a range of one unit, a difference between each transmission paths length STL0, STL2 and STL3 of the units UN0, UN2 and UN3, and transmission path length STL1 of the unit UN1. This allows the units UN0 to UN3 to be easily provided with uniform characteristics (e.g., transmission time delay), even if the number of external modules externally connected to the interface circuit 100 is changed.

According to the embodiment, the interface circuit 100 is implemented on one chip CHIP 100. For example, the controller 3, the interface circuit 100 and the bus 3 are implemented on one chip CHIP 100. This easily prevents from increasing a chip area.

It should be noted that the three external modules may be connected to the interface circuit 100. For example, units UN0, UN1 are switched to configuration indicated in FIG. 2, and units UN2, UN3 are switched to configuration indicated in FIG. 4. Alternatively, for example, units UN0, UN1 are switched to configuration indicated in FIG. 4, and units UN2, UN3 are switched to configuration indicated in FIG. 2. In interface circuit 100 illustrated in FIG. 4, the external module OM-1 may be connected to a unit UN0 and the external module OM-2 may be connected to units UN1-UN3.

Alternatively, interface circuit 100 may be provided with four or more units according to the number of external modules to be externally connected as desired. In this case, it is also possible to switch internal configurations of the interface circuit 100 according to the number of the external modules OM to be externally connected thereto.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An interface circuit comprising a plurality of units,
each of the plurality of units including:
a clock interface which receives a clock and transfers the clock;
a data interface which receives data and transfers the data; and
a selector which selects a clock and supplies the selected clock to the data interface such that the data interface transfers the data in synchronization with the selected clock.

2. The interface circuit set forth in claim 1, wherein
a selector of a first unit among the plurality of units always selects a clock transferred from a clock interface of the first unit, and supplies the selected clock to a data interface of the first unit.

3. The interface circuit set forth in claim 2, wherein
a selector of a second unit among the plurality of units selects either a clock transferred from the clock interface of the first unit or a clock transferred from a clock interface of the second unit, and supplies the selected clock to a data interface of the second unit.

4. The interface circuit set forth in claim 1, wherein
an arranged location of a unit including a clock interface that transfers a clock selected in a first priority is closer to a center of a line along a chip edge than an arranged location of a unit including a clock interface that transfers a clock selected in a second priority lower than the first priority.

5. The interface circuit set forth in claim 3, wherein
a priority of the clock transferred from the clock interface of the first unit is higher than a priority of the clock transferred from the clock interface of the second unit.

6. The interface circuit set forth in claim 3, wherein
in the plurality of units, an arranged location of the first unit is closer to a center of a line along a chip edge than an arranged location of the second unit.

7. The interface circuit set forth in claim 3, wherein
a selector of a third unit among the plurality of units selects either one of the clock transferred from the clock interface of the first unit, the clock transferred from the clock interface of the second unit, and a clock transferred from a clock interface of a third unit, and supplies the selected clock to a data interface of the third unit.

8. The interface circuit set forth in claim 7, wherein
both a priority of the clock transferred from the clock interface of the first unit and a priority of the clock transferred from the clock interface of the second unit are higher than a priority of the clock transferred from the clock interface of the third unit.

9. The interface circuit set forth in claim 7, wherein
in the plurality of units, both an arranged location of the first unit and an arranged location of the second unit are closer to a center of a line along a chip edge than an arranged location of the third unit.

10. The interface circuit set forth in claim 7, wherein
a priority of the clock transferred from the clock interface of the first unit is higher than a priority of the clock transferred from the clock interface of the second unit, and
both the priority of the clock transferred from the clock interface of the first unit and the priority of the clock transferred from the clock interface of the second unit are higher than a priority of the clock transferred from the clock interface of the third unit.

11. The interface circuit set forth in claim 7, wherein
in the plurality of units, an arranged location of the first unit is closer to a center of a line along a chip edge than an arranged location of the second unit, and
both the arranged location of the first unit and the arranged location of the second unit are closer to the center of the line along the chip edge than an arranged location of the third unit.

12. The interface circuit set forth in claim 7, wherein
a selector of a fourth unit among the plurality of units selects either the clock transferred from the clock interface of the first unit or the clock transferred from a clock interface of a fourth unit, and supplies the selected clock to a data interface of the fourth unit.

13. The interface circuit set forth in claim 12, wherein
a priority of the clock transferred from the clock interface of the first unit is higher than a priority of the clock transferred from the clock interface of the second unit, and
both the priority of the clock transferred from the clock interface of the first unit and the priority of the clock transferred from the clock interface of the second unit are higher than a priority of the clock transferred from the clock interface of the third unit and are higher than a priority of the clock transferred from the clock interface of the fourth unit.

14. The interface circuit set forth in claim 12, wherein
an arranged location of the first unit is closer to a center of a line along a chip edge than an arranged location of the second unit, and
both the arranged location of the first unit and the arranged location of the second unit are closer to the center of the line along the chip edge than both an arranged location of the third unit and an arranged location of the fourth unit.

15. The interface circuit set forth in claim 1, wherein
the interface circuit has a plurality of modes which has different internal configurations of the interface circuit from each other according to a number of external modules to be externally connected to the interface circuit.

16. The interface circuit set forth in claim 12 further comprising a plurality of transfer lanes,
wherein the plurality of transfer lanes including:
a first transfer lane corresponding to the first unit;
a second transfer lane corresponding to the second unit;
a third transfer lane corresponding to the third unit; and
a fourth transfer lane corresponding to the fourth unit, and wherein, in a first mode,
the interface circuit causes a connection between the data interface of the first unit and the first transfer lane to activate,
the interface circuit causes a connection between the data interface of the second unit and the second transfer lane to activate,
the interface circuit causes a connection between the data interface of the third unit and the third transfer lane to activate, and
the interface circuit causes a connection between the data interface of the fourth unit and the fourth transfer lane to activate.

17. The interface circuit set forth in claim 16, wherein,
in a second mode,
the interface circuit causes a connection between the data interface of the first unit and the first transfer lane to activate,
the interface circuit causes a connection between the data interface of the second unit and the first transfer lane to activate,
the interface circuit causes a connection between the data interface of the third unit and the third transfer lane to activate, and
the interface circuit causes a connection between the data interface of the fourth unit and the third transfer lane to activate.

18. The interface circuit set forth in claim 17, wherein,
in a third mode,
the interface circuit causes a connection between the data interface of the first unit and the first transfer lane to activate,
the interface circuit causes a connection between the data interface of the second unit and the first transfer lane to activate,
the interface circuit causes a connection between the data interface of the third unit and the first transfer lane to activate, and
the interface circuit causes a connection between the data interface of the fourth unit and the first transfer lane to activate.

19. A system comprises:
a controller;
the interface circuit set forth in claim 1 which receives a clock and data from an external module connected thereto, and
a bus which transfers data from the interface circuit to the controller with using the clock transferred from the external module.

20. The system set forth in claim 19, wherein
the bus is provided in accordance with a standard in which a transferring operation is performed in synchronization with the clock transferred from the external module.
